(19) United States
(12) Patent Application Publication
(10) Pub. No.: US 2004/0237535 A1
(43) Pub. Date: Dec. 2, 2004

(54) Method of operating a gas turbine

(76) Inventor: David Ainsworth, Southampton (GB)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/476,164

(22) PCT Filed: Apr. 26, 2002
(86) PCT No.: PCT/GB02/01904

(30) Foreign Application Priority Data
Apr. 26, 2001 (GB) 0110264.9

(51) Int. Cl. F02C 7/10

(52) U.S. Cl. 60/772; 60/39.511

(57) ABSTRACT

A micro turbine (10) has a recuperator (20). During startup, an alternator (26) acts as a motor to turn the turbine rotor (32) and compressor rotor (34) of gas turbine (40). The speed of the gas turbine (40) and a fuel control valve (42) are controlled in order to prevent the rate of change of temperature at a gas turbine exhaust sensor (74) and/or a recuperator sensor (80) from exceeding a predetermined value in order to reduce thermal shock on the recuperator during startup. Controlled shutdown sequences are also provided.

The present invention relates to a method of operating a gas turbine of a power generation apparatus, such as a micro turbine cogeneration system which is adapted to produce electricity and heat. The invention is particularly applicable to such systems having components such as heat exchangers such as recuperators downstream of the turbine of a gas turbine in the turbine exhaust path. The invention also relates to power generation apparatus having start control systems adapted to control gas turbine start and shutdown control systems for controlling shutdown.

In a conventional gas turbine start, there is normally a single thermal shock after ignition where the temperature approaches and may instantaneously exceed the continuous operating temperature limit of a turbine stage of the gas turbine and a recuperator located downstream of the turbine stage in the turbine exhaust flow path. Recuperators are relatively expensive components and the thermal shock of a recuperator may be life limiting. A given recuperator may, for example, be designed only to withstand 10,000 thermal shock cycles without leakage degradation which would lead to a reduction in system power and efficiency, and perhaps also safety.

Furthermore, gas turbine shutdown is not particularly carefully controlled in prior art systems and it may sometimes take a relatively long time for the recuperator, where provided, to cool down.

The present invention aims to alleviate the problems of the prior art.

According to a first aspect of the present invention, there is provided a method of operating a gas turbine of a power generation apparatus comprising controlling conditions to prevent a temperature characteristic of the apparatus from exceeding a predetermined value during startup or shutdown. The method is especially applicable to startup in which temperature increases are to be controlled. However the invention may also extend to shutdown sequences.

Preferably, the gas turbine has a compressor, a combustor and a turbine. Each of the compressor and turbine may comprise a single stage compressor or turbine, respectively, such as of the type having compressor rotor and turbine rotor mounted on a common shaft to rotate at the same speed.

The temperature characteristic is preferably an exhaust gas temperature characteristic, but may additionally, or alternatively, be a recuperator temperature characteristic (such as a recuperator inlet temperature characteristic which may be the same or substantially the same as a turbine exhaust gas temperature characteristic) of a recuperator of the gas turbine. For example, where a gas turbine has a recuperator, turbine exhaust gas temperature may equal recuperator inlet gas temperature and the temperature characteristic may be considered either as turbine exhaust gas temperature (EGT) or recuperator inlet temperature. The recuperator may be a plate and fin recuperator or a primary surface recuperator or of other suitable type. The advantages of the invention are particularly evident with plate and fin recuperators, and the invention is also advantageous for high start cycle, long-life units. Recuperator life may be optimised by a gradual warm up or cool down cycle. Incremental temperature changes, such as from startup to initial temperature peaks and/or from no load to maximum load exhaust gas temperature, may be controlled and/or prevented from exceeding predetermined values, e.g. absolute and/or rate of change. The apparatus may, instead of being a long-life unit be a short life application unit, such as a short-life mobile application apparatus.

Most preferably, the method includes preventing a rate of change of temperature from exceeding a predetermined value during startup or shutdown. Thus, thermal shock during startup or shutdown may be minimised and components of the gas turbine, such as a recuperator thereof, giving a longer life. The invention is particularly advantageous during startup when a high rate of change of temperature may exist over a prolonged period as the apparatus heats up from cold. It has been found that the rate of change of gas turbine exhaust gas temperature which may also be the recuperator gas inlet temperature where a recuperator is provided, may be critical to life optimisation of such a recuperator through thermal gradients causing differential thermal expansion. In one embodiment, the predetermined value is a rate of change value which is a value less then 600° C. per second. The predetermined value may be a value which is less than 400° C. per second. In one example, the predetermined value is about 350° C. per second. Thus, where the temperature is recuperator inlet temperature (which may also be turbine EGT) undesirable thermal shock caused by differential expansion between different parts of the recuperator may be minimised. The difference between recuperator inlet temperature and average bulk recuperator temperature may be controlled and prevented from exceeding an undesirable level.

The temperature characteristic may be an absolute temperature, such that the control of the apparatus is such that an absolute temperature is prevented from exceeding a predetermined value. It has been found that absolute inlet temperature to a recuperator may be critical through oxidisation, creep, and stress rupture of such a recuperator and, control of the apparatus to prevent the absolute temperature from exceeding a predetermined value is therefore highly advantageous. For example, the predetermined value may be a temperature value representative of temperature at the exit of a turbine of the gas turbine. The predetermined value may be a value which is less than 600° or 700° C., such as about 550° C.

The method may include controlling more than one temperature characteristic, such as both of an absolute temperature and a rate of change of temperature. Thus, in one example, recuperator inlet temperature may be controlled not to exceed 550° C. (or 700° C.) and rate of change of this temperature may be controlled not to exceed 350, 400 or 600° C. per second.

The method may include controlling a fuel valve for controlling the ingress of fuel into the apparatus during startup or shutdown. Preferably, temperature is sensed (such as turbine EGT or recuperator inlet temperature) and the fuel valve is controlled in response to sensed temperature to prevent the temperature characteristics (such as rate of change of temperature) from exceeding the predetermined value.

Preferably, a rotor of a generator is mounted to run on a common shaft with a compressor stage rotor and a turbine stage rotor of the gas turbine and the generator is operated during startup and/or shutdown as a motor to apply turning forces to the compressor stage rotor and turbine stage rotor. Accordingly, in preferred embodiments, a, for example direct drive, micro-turbine may be provided in which the gas turbine (or engine) may be motored at any desired speed and a temperature characteristic such as turbine exhaust gas temperature controlled for preventing undesirable conditions.

Preferably, the generator, while acting as a motor during startup or shutdown; is controlled to hold, or approximately hold, at least one held speed which is lower than the rated operation speed of the gas turbine. A said held speed may be held after gas turbine ignition and may therefore be held after temperature values begin to increase during startup. There may be a plurality of said held speeds, which may be different to idle or normal rated operation speed. During startup, a held speed during a purge may be approximately 18% of idle or rated speed. During startup, a speed, such as a held speed, for ignition may be approximately 14% of idle or rated speed. During start-up, the generator may be reconfigured or switched from acting as a motor to act as a generator at a speed, such as a held speed, which is about 30 to 70%, preferably about 40 to 60%, for example 60% of idle or rated speed.

A said held speed may be between 20% and 40% of rated gas turbine speed. Other said held speeds may be higher or lower. The generator, acting as a motor, may be controlled to dwell at a said held speed for a predetermined time. The predetermined time may be predetermined as a function of the thermal inertia of a recuperator of the apparatus.

Motor speed may be held or gradually ramped in response to signals sent from a temperature sensor, during startup or shutdown so as to prevent a temperature characteristic from exceeding a predetermined level.

The method may, when applied to a startup, include allowing at least one shaft of the gas turbine to accelerate up to a rated speed or idle speed thereof after being held at a said held speed. A said rated speed may be a rated speed of a rotor or shaft of the apparatus and may be defined by a maximum continuous operation speed thereof.

The method may, when applied to a startup, include increasing rotor speed up to a first value which is approximately half or less than half of the rated speed and then maintaining rotor speed at approximately said speed. At the same time, a temperature such as turbine exhaust gas temperature or recuperator inlet temperature may rise at up to a predetermined rate to a predetermined temperature value which is approximately 50% or in the region of 25% to 75% of the way between ambient and normal operating temperature thereof. After a predetermined dwell at the said held speed, rotor speed may be allowed to accelerate up to the rated speed while the temperature, such as turbine exhaust gas temperature or recuperator inlet temperature, is allowed to increase at a second predetermined rate which may be lower than the first predetermined rate, up to operating temperature.

The method may include at least one speed increase period in which rotor speed is increasing while fuel valve setting is held constant and/or at least one fuel valve increase period in which rotor speed is held constant while fuel valve setting is, increasing. The start sequence may switch between said speed increase and fuel valve increase periods one or more times during startup. A said speed increase period may be initiated as a temperature (e.g. recuperator inlet temperature exceeds a predetermined valve) is reached. A said fuel valve increase period may be initiated as a predetermined temperature drop from a maximum inflexion point occurs.

Thus, in preferred embodiments, the exhaust gas temperature profile of the gas turbine can be controlled on a turbo generator where the generator and turbine are attached on a single shaft and the generator is used as a motor to drive the turbine during the start or shutdown sequence. The start (or shutdown) sequence, including fuelling, speed and rate of change of exhaust gas temperature, as a function of time, can all be software controlled through a system controller of the apparatus. The exhaust gas temperature may, in a first startup embodiment, be allowed to rise over a period of approximately one second to a first value which is approximately 25% to 75% of the way from ambient to an operation value thereof and may then after approximately a further second be increased over a period of approximately 1-2 seconds to an operating temperature.

According to a further aspect of the invention there is provided an apparatus as set out in claim 25. The power generation apparatus may comprise a micro turbine system, such as a micro turbine co-gen system, or a larger system such as any gas turbine system incorporating a recuperator. Further aspects of the invention are set out in independent claims 38, 39 and 45. Various preferred features are set out in the dependent claims.

In preferred embodiments of the start sequence, where a recuperator is provided, recuperator inlet temperature rises initially to some proportion, e.g. a predetermined proportion, of a full rated temperature thereof, and the gas turbine/engine then dwells at this speed. The dwell period may be a function of the thermal inertia of the recuperator. The temperature of the recuperator matrix may be allowed to stabilise such that the bulk temperature in the recuperator comes relatively uniform. Once this has been achieved, the engine/gas turbine may be allowed to accelerate to the full rated speed thereof. During this transition, the peak temperature obtained is historically lower than in prior art start sequences in which the peak temperature has been higher than operating temperature. Furthermore, the rate of change of temperature is maintained relatively low and undesirable temperature differentials resulting in thermal shock of the recuperator are reduced. Accordingly, when a recuperator is provided, recuperator thermal shock can be significantly reduced during engine starting, especially with direct driven alternators in turbo generators in which the alternator rotor is mounted on a common shaft at least with a turbine stage of a turbine of a gas turbine. The alternator may though be on a separate shaft. During starting, the alternator can be used in the preferred embodiments as a motor to hold one or more, i.e. various, speeds during the engine start cycle and, accordingly, the exhaust gas temperature, the gas turbine may be limited in order to reduce the overall thermal shock, i.e. rate of change of temperature as a function of time, on the recuperator. At a desired point, the alternator may be switched from a motoring mode of operation to a run mode for generating electricity.

The present invention may be carried out in various ways. Various preferred methods of starting and shutting down a gas turbine of a power generation apparatus in accordance with the invention and a preferred apparatus will now be described by way of example with reference to the accompanying drawings, in which:

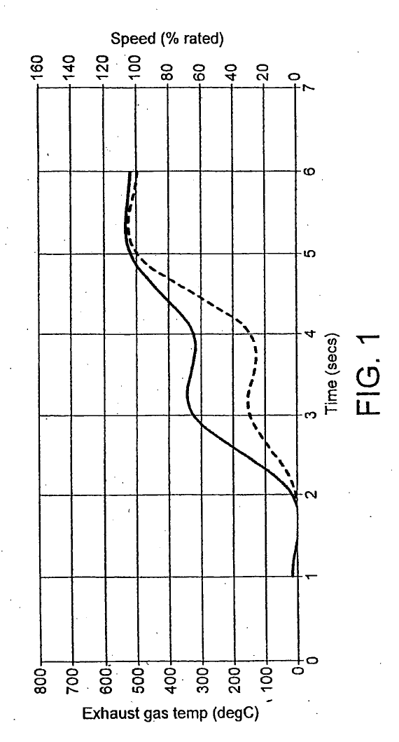

FIG. 1 is a diagram showing various start characteristics in a preferred method;

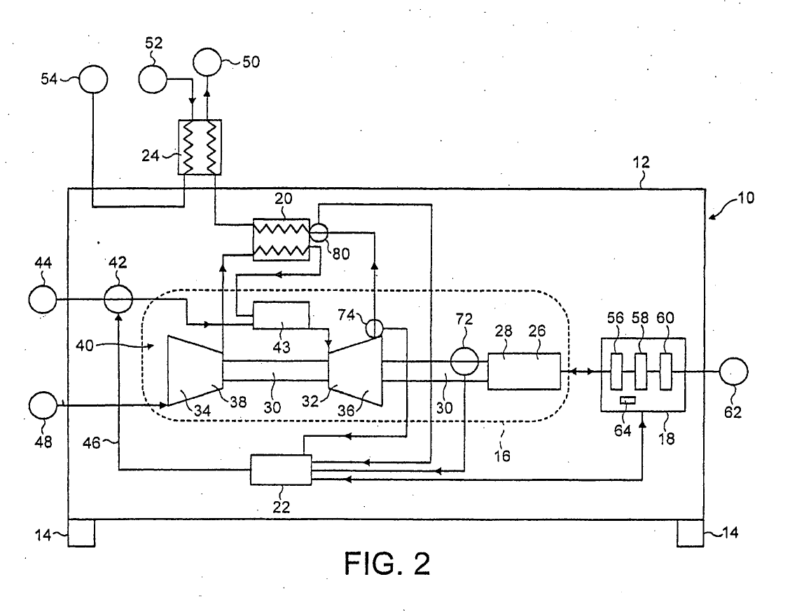

FIG. 2 is a schematic side view of a micro turbine having a turbo alternator with a gas turbine operated in accordance with a preferred embodiment of the present invention.

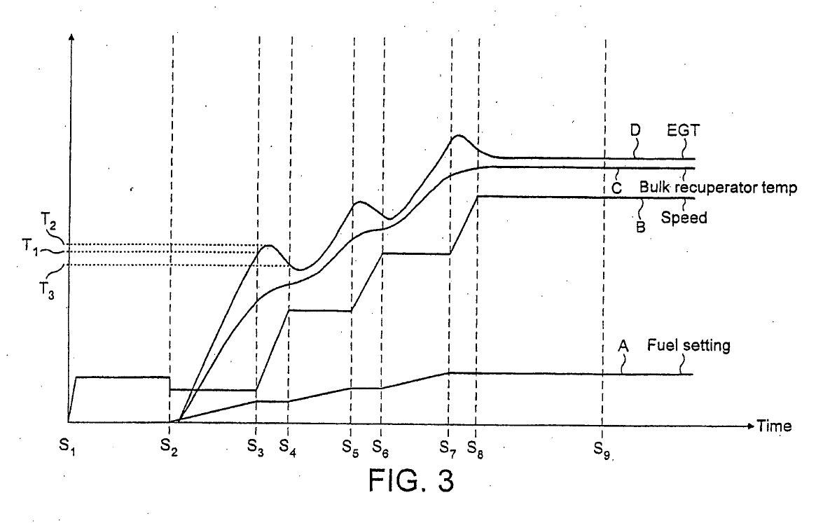

FIG. 3 shows a second preferred start sequence;

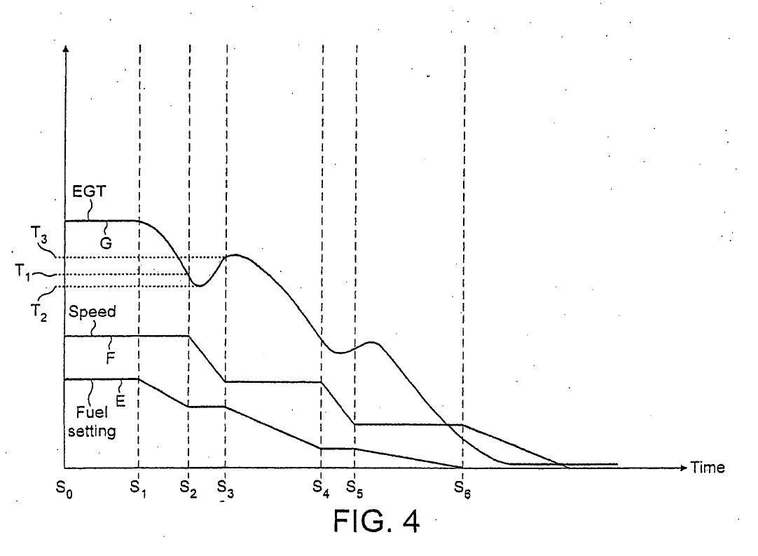

FIG. 4 shows a preferred shutdown sequence; and

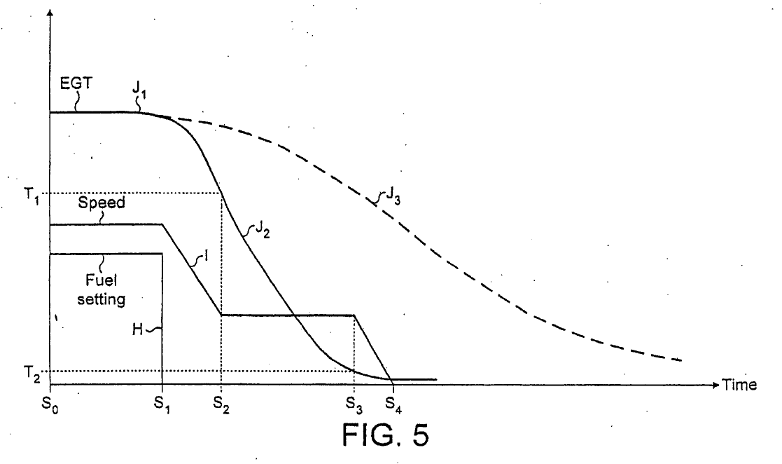

FIG. 5 shows another preferred shutdown sequence.

Referring to FIG. 2, a transportable micro turbine 10 has a generally oblong cabinet 12 which is in size approximately 3 m long, 2 m wide and 2 m tall. The cabinet is supported by feet 14 and may be conveniently transported after assembly for use and servicing.

Inside the cabinet 12 there is located a turbo generator 16, a power conditioner 18, a recuperator 20 and a software controlled micro processor control unit 22. A boiler 24 is located on top of the cabinet 12.

The turbo generator 16 includes an alternator 26 having a rotor 28 which is mounted on a common shaft 30 with turbine 32 and compressor 34 stages of a turbine 36 and compressor 38 of a gas turbine 40. A combustor 43 is also provided which is fed with fuel, such as gaseous fuel from a fuel source 44 and controlled by a fuel control valve or assembly 42 in response to signals received along a signal path 46 from the control unit 22.

During operation of the micro turbine 10, air is drawn from an air inlet 48 into the compressor 38. The compressed air then passes through the recuperator 20 and into the combustor 43 where it reacts with fuel drawn into the combustor 43 through the fuel inlet 44 controlled by the fuel control valve 42. The combusted products are passed through the turbine 36 and then the recuperator 20 and boiler 24 to an exhaust stack 50. Cold water passes from a cold water inlet 52 through a boiler 24 to a hot water outlet 54. The alternator rotor 28 provides electrical power through the power conditioning unit, which may include a rectifier 56, inverter 58 and filter 60, to an electrical load 62.

During startup of the micro turbine 10, the alternator/generator 26 is used as a motor, driven from a battery 64 from the power conditioning unit 60, using the inverter 58 on a pulse width modulated basis to control the speed of the shaft 30. The alternator may then be switched from the motor mode into a new mode in which it supplies the load 62.

As shown in FIG. 1, during startup, at a two second point the speed of the shaft 30 shown in dotted lines in FIG. 1, measured by a speed sensor 72 first rises over a period of about 1 second to about 30% of the rated speed of the shaft 32. During this period, the recuperator inlet temperature (shown by a solid line in FIG. 1), measured by thermocouple 80 rises at a rate of about 350° C. per second to about 300° to 350° C., after ignition, and thus commencement of temperature increase. The fuel control valve 42, during that period, is operated by the control unit 22 to ensure that the rate of change of recuperator inlet gas temperature (which may equal or very nearly equal turbine exhaust gas temperature (EGT) does not exceed 350° C. per second and the temperature measured at recuperator inlet temperature sensor 80 does not exceed 400° C. Alternatively, these limits may be applied to turbine EGT measured at turbine EGT sensor 74, but it is preferred practice at present to measure recuperator inlet temperature, i.e. using sensor 80. Turbine EGT will be very close to or the same as recuperator inlet temperature such that the two may, in this embodiment, be considered equal. The motor/alternator 26 dwells at approximately 30% of the shaft rated speed for about 1 second, while the exhaust gas temperature also dwells. Then, the motor/alternator 26 and fuel control valve 42 are operated to bring the shaft speed and turbine exhaust gas temperature to their normal operating conditions of 100% rated speed and about 500° to 550° C. over a period of about 2 seconds. Accordingly, it is noted that the exhaust gas temperature does not form a high peak that is substantially higher than 500° C. Thus, thermal shock problems are reduced.

In the case of a start cycle for a gaseous fuel apparatus, such as a natural gas powered apparatus, the alternator/motor 26 may be used for some seconds prior to ignition in order to run a purge of the gases in the apparatus/micro turbine 10.

A second preferred start sequence which incorporates a purge is shown in FIG. 3 in which the X axis represents time, graph A represents fuel control valve (42) setting, graph B represents speed of the shaft 30, graph C is representative of the bulk temperature of the recuperator 20 and graph E represents recuperator inlet temperature measured by the sensor 80 which may sometimes be called EGT since it is very close to or the same as turbine exhaust gas temperature. At time S₁ the start sequence is initiated by running the shaft speed up to about 18,000 rpm (which might be about 18% of rated speed) using the alternator 26 as a motor, so as to purge any undesirable remaining levels of natural gas from the system before ignition. After the purge, at time S₂, the motor is slowed to about 14,000 or 15,000 rpm (which might be about 14 or 15% of rated speed) and the igniter (not shown) for the combustor 43 is activated. At the same time, while speed is held constant, the setting of the fuel control valve 42 is steadily increased up to time S₃. If no EGT is detected within 6 seconds of igniter activation, the system is shut down. It will be seen that the exhaust gas temperature and therefore bulk recuperator temperature begin to rise shortly after time S₂ as ignition of the gas turbine occurs. When EGT (recuperator inlet temperature) reaches temperature T₁ (as sensed by sensor 80), control of the shaft speed and dual control valve setting is switched to a speed increase mode in which speed is steadily increased while fuel control valve setting is maintained constant. Accordingly, due to the increase in speed without corresponding increase of fuel setting, EGT peaks at a maximum T₂ and then falls back between time S₃ and time S₄. When exhaust gas temperature drops a predetermined amount from temperature T₂, i.e. to temperature T₃, the system is switched from the speed increase mode to a fuel setting increase mode in which the speed is maintained constant by the motor 26 and the fuel setting is steadily increased again in the time period between time S₄ and time S₅. At time S₅, the EGT again reaches a predetermined temperature, like temperature T₁ before, except this time higher. Thus a further speed increase mode occurs between time S₅ and time S₆ and then after a second predetermined temperature drop from the second EGT maximum peak, a further fuel setting increase mode is entered in which speed is maintained constant while the fuel control valve setting is steadily increased. At time S₇, a further predetermined EGT is reached and another similar speed increase mode occurs between time S₇ and time S₈. At time S₈, which is defined by the point in time at which there is a further third predefined temperature drop from a third temperature maximum occurring shortly after time S₇, the alternator/motor 26 is reconfigured as an alternator/generator 26 since the gas turbine has a reached a state of self-sustained operation and after time S₈, the gas turbine shaft may be at an idle or normal operating speed. From the point in time S₈ of reconfiguration of the alternator 26, the fuel control valve 42 may be controlled closed loop based upon shaft speed. Prior to the reconfiguration, the fuel control valve may be controlled open loop or closed loop based for example on EGT. At point in time S₉, once the system has stabilised, the difference between EGT and the bulk recuperator temperature may be about 30° C. It will be noted that the preferred start sequence as shown in FIG. 3 is advantageous in that recuperator inlet temperature or EGT does not increase substantially ahead of the bulk recuperator temperature and therefore, the recuperator components are not subject to substantial differential expansion and thermal shock. Instead of motoring the shaft up to the idle speed at time S₈ shown in FIG. 3, it would be appreciated that the shaft may be motored up to a speed lower than the idle or normal operating speed, preferably with one or more speed increase and/or fuel control setting increase periods, and the alternator 26 may be reconfigured to a generate mode at this lower shaft speed, thereby allowing the gas turbine shaft to accelerate up to its idle or normal operating speed under its own power. The recuperator in this COGEN example may be lifed to 1000 starts and/or 30,000 hours. On a standby system, it may be lifed to 3000 starts and/or 8,000 hours. The purge may only be present for some types of fuel such as natural gas. If diesel or other suitable fuel is used, a purge may not be included. The idle or operating speed may be about 100,000 rpm. The alternator may in some embodiments be switched from motoring to normal generate modes at about 60,000 rpm (e.g. about 30 to 70%, or about 40 to 60% of rated speed).

FIG. 4 shows a preferred shutdown sequence for the system in which graph E represents the setting of the fuel control valve 42, graph F represents shaft speed and graph G EGT or recuperator inlet temperature. At time S₀ in FIG. 4, the system is idling. Shutdown is initiated at time S₁ when alternator 26 is reconfigured from its normal generating mode as a motor to drive the shaft 30. Additionally, in the time period between time S₁ and time S₂, the fuel valve control setting is steadily decreased in this fuel valve decrease mode period. When EGT has decreased to temperature T₁, the system is switched to a speed decrease mode in which the motor 26 steadily decreases shaft speed and the fuel setting is maintained constant. Time S₃ is defined by the time when EGT rises a predetermined amount above the minimum inflection point T₂, i.e. when it rises to temperature T₃. The system then enters a further fuel setting decrease mode which is followed by alternating speed decrease and fuel setting decrease modes until EGT is brought back to ambient temperature. It will be seen that EGT is brought down in a controlled manner in the shutdown sequence of FIG. 4 and again, bulk recuperator temperature (although not shown) is maintained relatively close to EGT, so that the recuperator is not subject to too severe thermal stresses during shutdown. The controlled shutdown may be beneficial when it is necessary to reduce recuperator bulk temperature fairly quickly but in a controlled manner and without causing thermal stress.

A further preferred shutdown sequence is shown in FIG. 5 in which graph H shows fuel control valve setting, graph I shaft speed, graph J₁, J₂ EGT. Fuel mass flow may be a function of fuel valve setting and the square of shaft speed. At time S₀, the system is running at idle or normal operating speed. At time S₁, the fuel control valve is shut off and the alternator is reconfigured as motor 26, entering a speed decrease mode in which shaft speed is gradually decreased. When EGT reaches temperature T₁, speed is then held constant by the alternator acting as a motor 26. Then when EGT reaches temperature T₂, the speed is steadily decreased to zero. If at time S₁ speed had been reduced quickly to zero along with fuel setting, instead of progressing through curve J₂ in a controlled manner down to ambient temperature, EGT graph would have continued along the line J₃, thus meaning that it would take a relatively long time to reduce recuperator temperature below a certain value if, for example, desired for a restart. Thus, like the shutdown sequence described with reference to FIG. 4, the shutdown sequence described with reference to FIG. 5, allows the recuperator inlet temperature and bulk recuperator temperature to be reduced in a controlled manner, enabling a relatively quick shutdown without adversely thermally stressing the recuperator. The sequence described with reference to FIG. 5 may be selected when a restart is necessary whereas the shutdown sequence described with reference to FIG. 4 may be selected when it is desirable to switch off the apparatus for a relatively lengthy period.

Various changes may be made to the embodiments described within the scope of the invention as defined by the accompanying claims as interpreted under patent law.

1. A method of operating a gas turbine of a power generation apparatus comprising controlling conditions to prevent a temperature characteristic of the apparatus from exceeding a predetermined value during startup or shutdown.

2. A method as claimed in claim 1 in which the gas turbine has a compressor, a combustor and a turbine.

3. A method as claimed in claim 1 in which the temperature characteristic is an exhaust gas temperature characteristic.

4. A method as claimed in claim 1 in which the temperature characteristic is a recuperator temperature characteristic of a recuperator of the gas turbine.

5. A method as claimed in claim 1 which includes preventing a rate of change of temperature from exceeding a predetermined value during startup.

6. A method as claimed in claim 5 in which the predetermined value is a value which is less that 600° C. per second.

7. A method as claimed in claim 5 in which the predetermined value is a value which is less than 400° C. per second.

8. A method as claimed in claim 5 in which the predetermined value is about 350° C. per second.

9. A method as claimed in claim 1 in which the temperature characteristic is an absolute temperature which is prevented from exceeding a predetermined value.

10. A method as claimed in claim 1 in which the controlling of the conditions during startup or shutdown includes controlling a fuel valve for controlling the ingress of fuel into the gas turbine of the apparatus, whereby the temperature characteristic may be controlled.

11. A method as claimed in claim 10 in which the setting of the fuel valve is steadily increased during a fuel valve increase period during startup.

12. A method as claimed in claim 10 in which the setting of the fuel valve is maintained constant during a mode during startup.

13. A method as claimed in claim 1 in which a motor is employed to control a shaft speed of the gas turbine during startup.

14. A method as claimed in claim 2 in which a rotor of a generator is mounted to run on a common shaft with a compressor stage rotor and a turbine stage rotor of the compressor and turbine, and in which the generator is operated during starting or shutdown as a motor to apply turning forces to the compressor stage rotor and turbine stage rotor.

15. A method as claimed in claim 13 in which the motor is controlled to hold, or approximately hold, at least one held speed which is lower than the rated operation speed of the apparatus, whereby the temperature characteristic may be controlled.

16. A method as claimed in claim 15 in which, during startup, said held speed is held after gas turbine ignition.

17. A method as claimed in claim 15 in which a said held speed between 20% and 40% of rated operation speed of the apparatus.

18. A method as claimed in claim 15 in which the generator, acting as a motor, is controlled to dwell at said held speed for a predetermined time.

19. A method as claimed in claim 18 in which the predetermined time is predetermined as a function of thermal inertia of a recuperator of the apparatus.

20. A method as claimed in claim 15 in which, during startup includes allowing the gas turbine to accelerate up to a rated operation speed or an idle speed thereof after being held at said held speed.

21. A method as claimed in claim 1 which includes measuring a temperature characteristic with a sensor and sending a signal to a control unit, the control unit being adapted to send a further signal to control conditions in response to the temperature characteristic.

22. A method as claimed in claim 21 which includes measuring recuperator inlet temperature.

23. A method as claimed in claim 21 which includes initiating one or more speed increase modes in which turbine speed is steadily increased, each said speed increase mode being initiated when recuperator inlet temperature reaches one or more predetermined values.

24. A method as claimed in claim 22 which includes initiating a fuel control setting increase mode, each said fuel control value setting increase made being initiated as recuperator inlet temperature falls back one or more predetermined amounts from a maximum inflexion point.

25. A power generation apparatus having a gas turbine and a start and/or shutdown control system adapted to prevent a temperature characteristic of the apparatus from exceeding a predetermined value during startup and/or shutdown.

26. An apparatus as claimed in claim 25 in which the gas turbine has a compressor, a combustor and a turbine.

27. An apparatus as claimed in claim 25 in which the temperature characteristic is an exhaust gas temperature characteristic.

28. A method as claimed in claim 25 in which the temperature characteristic is a recuperator temperature characteristic of a recuperator of the gas turbine.

29. An apparatus as claimed in claim 27 which includes means for preventing a rate of change of temperature from exceeding a predetermined value during startup.

30. An apparatus as claimed in claim 29 in which the predetermined value is less than 600° C. per second.

31. An apparatus as claimed in claim 29 in which the predetermined value is about 350° per second.

32. An apparatus as claimed in claim 26 in which the temperature characteristic is an absolute temperature and means are provided for preventing the absolute temperature from exceeding a predetermined value.

33. An apparatus as claimed in claim 26 which includes a fuel valve and means are provided for controlling the fuel valve during startup or shutdown for controlling the ingress of fuel into the gas turbine of the apparatus.

34. An apparatus as claimed in claim 33 which includes a temperature sensor and in which the fuel valve is controlled in response to signals transmitted along a signal path from the sensor to a control unit.

35. An apparatus as claimed in claim 25 in which a rotor of the generator is mounted to run on a common shaft with a compressor stage rotor and a turbine stage rotor of a compressor and a turbine of the gas turbine and in which the generator is adapted to operate as a motor during startup or shutdown for applying turning forces to the compressor stage rotor and turbine stage rotor.

36. An apparatus as claimed in claim 35 in which the generator, while acting as a motor during startup or shutdown, is adapted to be controlled to hold, or approximately hold, at least one held speed which is lower than a rated operation speed of the apparatus.

37. An apparatus as claimed in claim 36 in which a said held speed is between 20% and 40% of rated operation speed of the apparatus.

38. A method of shutting down a gas turbine comprising preventing a rate of change of temperature form exceeding a predetermined value during shutdown.

39. A method of shutting down a gas turbine comprising using a motor to control speed of a shaft of the gas turbine during shutdown.

40. A method as claimed in claim 39 which includes reconfiguring a generator powered by the shaft in a run mode of the gas turbine as a motor and using the motor to hold one or more held speeds of the gas turbine shaft during shutdown.

41. A method as claimed in claim 40 in which speed is decreased by the motor steadily to a second said held speed during shutdown.

42. A method as claimed in claim 40 in which speed is decreased to zero steadily after maintenance of a said held speed.

43. A method as claimed in claim 39 in which a fuel valve control setting is steadily decreased while speed is maintained constant during at least one fuel valve decrease mode during shutdown.

44. A method as claimed in claim 39 in which speed is steadily decreased and fuel valve setting is maintained constant during at least one speed decrease mode during shutdown.

45. A method of starting a gas turbine of a power generation apparatus comprising controlling conditions to prevent a temperature characteristic of the apparatus from exceeding a predetermined value during startup.

46. (Cancelled).

47. (Cancelled).

48. (Cancelled).

49. An apparatus as claimed in claim 25 in which the system is a start control system.

50. An apparatus as claimed in claim 25 in which the system is a shutdown control system.
